(19) United States
(12) Patent Application Publication
(10) Pub. No.: US 2015/0314565 A1
(43) Pub. Date: Nov. 5, 2015

(54) Construction Panel

(71) Applicant: SAINT-GOBAIN PLACO SAS, Suresnes (FR)

(72) Inventors: Glen HOTCHIN, Coventry (GB); Nicholas JONES, Melton Mowbray (GB)

(21) Appl. No.: 14/651,823

(22) PCT Filed: Dec. 12, 2013
(86) PCT No.: PCT/EP2013/076328

§ 371 Date: Jun. 12, 2015

(30) Foreign Application Priority Data
Dec. 12, 2012 (EP) 12290434.5
Jun. 11, 2013 (EP) 13290132.3

(51) Int. Cl. B32B 13/12; B32B 5/02; B32B 5/10; B32B 7/02; B32B 27/32; B32B 27/12; B32B 27/30; B32B 27/36; B32B 27/34; B32B 27/42; B32B 13/14; B32B 27/06

(52) U.S. Cl. CPC B32B 13/12; B32B 13/14; B32B 5/022; B32B 5/10; B32B 7/02; B32B 27/06; B32B 27/12; B32B 27/304; B32B 27/365; B32B 27/34; B32B 27/42; B32B 27/32; B32B 2307/54; B32B 2419/00; B32B 2307/536; B32B 2262/101; B32B 2607/00

(57) ABSTRACT

A panel for use in building construction comprises a plasterboard having two opposed faces, a polymer-based lamina being provided on one of these faces. The polymer-based lamina is characterised in that it is provided by a material for which the work done under uniaxial tensile stress to achieve a tensile strain of up to 0.12 is greater than 2.1 MJ/m³.

The present invention relates to panels for use in building construction and the manufacture thereof. In particular the present invention relates to panels for providing partitions to which items such as sinks, televisions, or radiators may be affixed.

Light-weight panels such as plasterboard (e.g. gypsum plasterboard), polystyrene board and fibreboard are commonly used to provide partitions within buildings. Their advantages for this application include the fact that they are light and quick to install.

However, in certain cases, such light-weight panels may have the drawback that they are not strong enough to support fixtures (e.g. sinks, televisions, radiators, fire extinguishers, shelves and any other item that requires attachment to the panel). In such cases, the weight of the fixture may cause the fixing means (e.g. screws) to be pulled out of the panel, such that the fixture falls away from the partition.

Typically, this problem has been addressed by providing plywood sheets to increase the fixing strength of the panel. In this case, the plywood sheet is provided on the side of the panel opposite to that on which the fixture is to be located. The plywood sheet may provide increased strength for retaining one or more fixing means (e.g. screws) employed to secure the fixture to the panel. Typically, the plywood sheet is positioned within the building framework, and the plasterboard then fixed to the plywood, so that it lies outside the building framework.

As an alternative, metal support means may be provided. These may comprise fixing plates, channels, straps, or metal fasteners. As is the case for plywood sheets, the metal support means are generally positioned on the side of the panel opposite that to which the fixture is to be secured, and act to receive and secure fixing means, e.g. fixing screws, that are used to attach the fixture to the panel.

Both these arrangements have the disadvantage that they require the additional supporting components to be joined to the panel on-site. Moreover, when metal support means are used, a plurality of such support means may be needed to support the full set of fixing means required to secure the fixture to the panel. Thus, installation process may be time-consuming and expensive.

Furthermore, the addition of metal support means or plywood sheets increases the weight and thickness of the partition, and/or results in a reduction in cavity wall space. In general, the plywood itself must be cut to size on site, thus increasing the time required for installation and possibly leading to the release of dust and potentially harmful components.

Therefore, there is a need to provide improved panels that are able to retain fixing means and support fixtures, and that do not require time-consuming installation processes.

Further to the above-defined problem, the present inventors have found that any reinforcements for the panels must be carefully selected so as to allow screw fixings to be inserted in a reliable and reproducible manner. In particular, it has been found that reinforcements should be selected so as to reduce the likelihood of overtightening of screw fixings. The term “overtightening” relates to the process by which the inner surface of a screw hole can easily be stripped by the screw if the screw is turned too far, with the result that the screw is then no longer retained securely in the panel.

It has been found that this problem may be reduced by selecting a reinforcement for the panel, wherein the work required to deform the material of the reinforcement is sufficiently high as to limit the sensitivity to overtightening.

Therefore, at its most general, the present invention may provide a panel that is reinforced with a backing lamina, the deformation characteristics of the material of the backing lamina being such as to reduce the occurrence of stripping of screw hole threads formed in the lamina.

In a first aspect, the present invention may provide a panel for use in building construction, the panel comprising a plasterboard having two opposed faces, a polymer-based lamina being provided on one of the faces of the plasterboard,
the polymer-based lamina being characterised in that is thinner than the plasterboard and in that it is provided by a material for which the work done under uniaxial tensile stress to achieve a tensile strain of up to 0.12 is greater than 2.1 MJ/m³.

The panel is for use in mounting on a support structure to provide a partition, such that the side of the panel on which the polymer-based lamina is provided faces towards the support structure.

Typically, the work done under uniaxial tensile stress is calculated by measuring the area under a curve of stress plotted against strain for a particular material.

In the case that a material fails at a tensile strain less than 0.12, then the polymer-based lamina is characterised by the work done up to failure of the specimen.

In the case that a material fails at a tensile stress greater than 0.12, then the polymer-based lamina is characterised by the work required to achieve a strain of 0.12.

Preferably, the polymer-based lamina is provided by a material for which the work done under uniaxial tensile stress to achieve a tensile strain of up to 0.12 is greater than 2.9 MJ/m³, more preferably greater than 3.8 MJ/m³.

The lamina represents a layer that provides a discrete component of the panel, that is, it is not integrally formed with the substrate. Effectively, there is a well-defined interface or boundary between the substrate and the lamina.

In certain cases, the polymer-based lamina may only cover one or more portions of the face of the board, such that one or more “fixing portions” are provided.

Preferably, the polymer-based lamina comprises principally a thermoplastic polymer. Alternatively, the polymer-based lamina may principally comprise a thermosetting polymer.

The polymer-based lamina may be provided by a monolithic polymer, that is, a unitary, non-composite material. Alternatively, the polymer-based lamina may be provided by a composite material having a polymeric matrix, for example, a fibre-reinforced polymer. In this case, the polymer-based lamina may be reinforced by polymeric fibres (e.g. cellulose fibres). Alternatively, the polymer-based lamina may be reinforced by inorganic fibres, e.g. glass fibres. In certain cases, the fibres and matrix of the fibre-reinforced polymer are provided by the same polymer. An example of such a composite is a self-reinforced polypropylene composite in which both the fibres and the matrix consist of polypropylene, this composite being available under the trade name Curv™.

Typically, the plasterboard comprises gypsum plaster extruded between two paper or glass fibre sheets. The gypsum plaster may comprise various additives as generally known in the art.

Typically, the polymer-based lamina is glued to the plasterboard. However, in other embodiments, the polymer-based lamina may be formed from a resin that is deposited on the board and allowed to cure.

Typically, the lamina has a thickness of at least 0.25 mm, preferably at least 0.5 mm, more preferably at least 1 mm. Such thickness may provide the necessary stiffness to the lamina, such that it can improve the fixing strength of the panel.

Typically, the thickness of the lamina is less than 4 mm, preferably less than 3 mm, more preferably less than 2.5 mm. In certain cases, e.g. in the case that the polymer-based lamina is a composite mat (for example, a self-reinforced composite), the thickness may be less than 2 mm. It is desirable to limit the thickness of the lamina, so that when the panel is installed to provide e.g. a wall, its footprint within the building structure is not too great. For reference, plywood reinforcements typically have a thickness of around 12 mm.

Typically, the thickness of the lamina is less than the thickness of the plasterboard. Preferably, the thickness of the polymer-based lamina is less than 25% of the thickness of the plasterboard, more preferably less than 20%.

A typical panel may comprise a gypsum plasterboard of 10-20 mm thickness, and may have a total thickness of approximately 11-25 mm.

Typically, the lamina is solid and non-porous. This may assist in providing the lamina with the necessary stiffness to improve the fixing strength of the panel. The phrase “solid and non-porous” is intended to exclude laminae that comprise a 3-dimensional porous array. The phrase is not intended to exclude laminae that have apertures, cut-outs, or perforations extending through the thickness of the lamina. For example, it is envisaged that the lamina may include a 2-dimensional distribution of through-thickness apertures.

In general, the polymer-based lamina is selected from the group comprising: polyvinylchloride, polycarbonate, nylon, acetal, self-reinforced polypropylene, and Bakelite™.

In general, the tensile strength at yield of the polymer-based lamina is at least 50 MPa and the modulus of elasticity in tension of the lamina is at least 2500 MPa.

In certain embodiments, a further lamina may be provided on the outer surface of polymer-based lamina (that is, distal to the plasterboard). The further lamina may be, for example, an insulating layer, a paper layer, or a metal (e.g. copper) layer.

In other embodiments, a thin film may be provided directly on the surface of the plasterboard, on the inner face of the polymer-based lamina, or on the outer face of the polymer-based lamina.

In still further embodiments, a paper layer may be provided over the outer surface of the polymer-based lamina.

In a second aspect, the present invention may provide a panel for use in building construction, the panel comprising a plasterboard having two opposed faces, a fibreglass sheet being provided on one of the faces of the plasterboard,
wherein the fibreglass sheet comprises a non-woven mat that is impregnated with resin, the Young's Modulus of the fibreglass sheet being in the range of 4500-8000 MPa.

Preferably, the Young's Modulus of the fibreglass sheet is in the range 5000-7500 MPa, more preferably in the range 6000-7000 MPa.

Preferably, the glass fibre content of the fibreglass sheet is greater than 25 wt %, more preferably greater than 30 wt %.

Preferably, the Young's Modulus of the resin is less than 4500 MPa, more preferably less than 4000 MPa.

In general, the Young's Modulus of the resin is greater than 2000 MPa, preferably greater than 2500 MPa, more preferably greater than 3000 MPa.

The panel according to the second aspect of the invention may include one or more features of the panel according to the first aspect of the invention.

In a third aspect, the present invention may provide a panel for use in building construction, the panel comprising a plasterboard having two opposed faces, a polymer-based lamina being provided on one of the faces of the plasterboard,
wherein the polymer-based lamina is characterised in that its principal constituent by weight is a thermoplastic material having a Vickers indentation hardness greater than 0.06 GPa.

Preferably, the Vickers hardness is greater than 0.09 GPa, more preferably greater than 0.11 GPa.

The panel according to the third aspect of the invention may include one or more features of the panel according to the first aspect of the invention.

In a fourth aspect, the present invention may provide a panel for use in building construction, the panel comprising a substrate board having two opposed faces, a polymer-based lamina being provided on one of the faces of the substrate board,
wherein the polymer-based lamina is configured such that when a No. 10 woodscrew is screwed into the lamina, the work done in tightening the screw, after maximum torque has been achieved is at least 7.7 J.

In general, the torque required to tighten the screw within the polymer-based lamina has a peak value of at least 1.68 Nm.

The work required to tighten the woodscrew is given by the area below a graph of tightening torque versus rotation angle, measured between the rotation angles of zero (corresponding to peak torque) and 7.85 radians. The value of 7.85 radians is selected because it corresponds to 1.25 turns of the screw. It has been found that when installing fixtures, the installers typically turn each screw for about one complete extra turn after peak torque has been reached. Thus, it is important that the lamina should be configured to continue to provide resistance to screw turning (i.e. to avoid stripping of the screw thread) over this angular range.

A No. 10 woodscrew has a length of 50 mm and a diameter of 5 mm.

In a fifth aspect, the present invention may provide a panel for use in building construction, the panel comprising a substrate board having two opposed faces, a polymer-based lamina being provided on one of the faces of the substrate board,
wherein the tensile strength at yield of the polymer-based lamina is at least 50 MPa, and the modulus of elasticity in tension of the lamina is at least 2500 MPa.

In a sixth aspect, the present invention may provide a panel for use in building construction, the panel comprising a substrate board having two opposed faces, a polymer-based lamina being provided on one of the faces of the substrate board,
wherein the polymer-based lamina is provided by a material having a fracture toughness greater than 1 MPa·m^{1/2}.

Preferably, the polymer-based lamina is provided by a material having a fracture toughness greater than 1.5 MPa·m^{1/2}, more preferably greater than 2 MPa·m^{1/2}.

In a sixth aspect, the present invention may provide a partition comprising at least one panel according to any one of the preceding claims, the panel being mounted onto a support structure, wherein the side of the panel on which the polymer-based lamina is provided faces towards the support structure.

Effectively, therefore, the panel is oriented such that the polymer-based lamina is provided on the back of the panel. Thus, fixtures may be mounted on the front of the panel, while the polymer-based lamina on the back of the board may serve to provide improved retention of the fixtures to the board.

Typically, the partition comprises two panels that are positioned each on a respective side of the support structure.

The partition may be upright, for example to provide a wall, or it may be arranged on a level, for example to provide a ceiling.

The sixth aspect of the invention may include one or more of the optional features of the first to fifth aspects of the invention.

Certain aspects and features of the present invention will now be described by way of example, with reference to the following Figures:

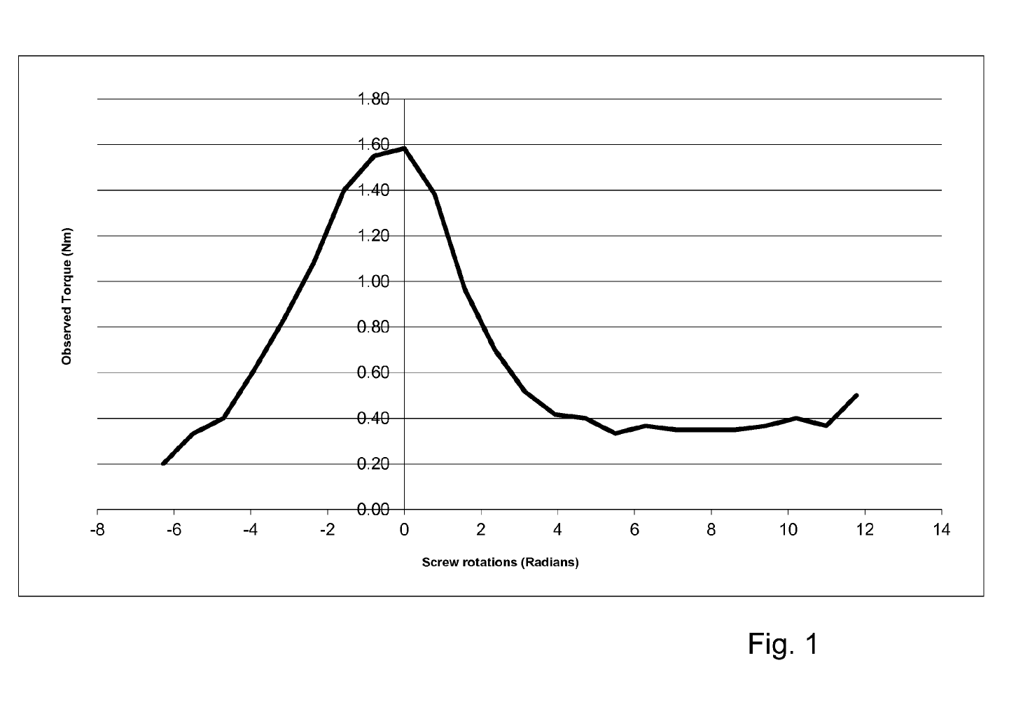

FIG. 1 is a schematic graph of torque against rotation angle.

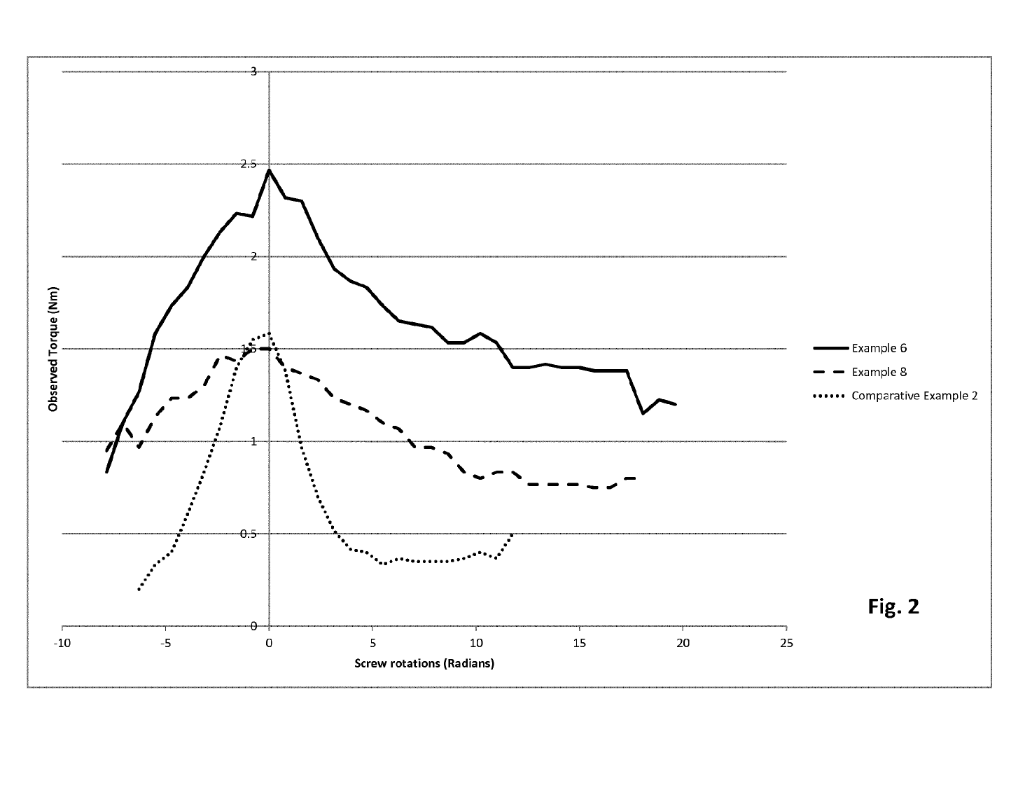

FIG. 2 is graph of torque against rotation angle for Example 6, Example 8 and Comparative Example 2.

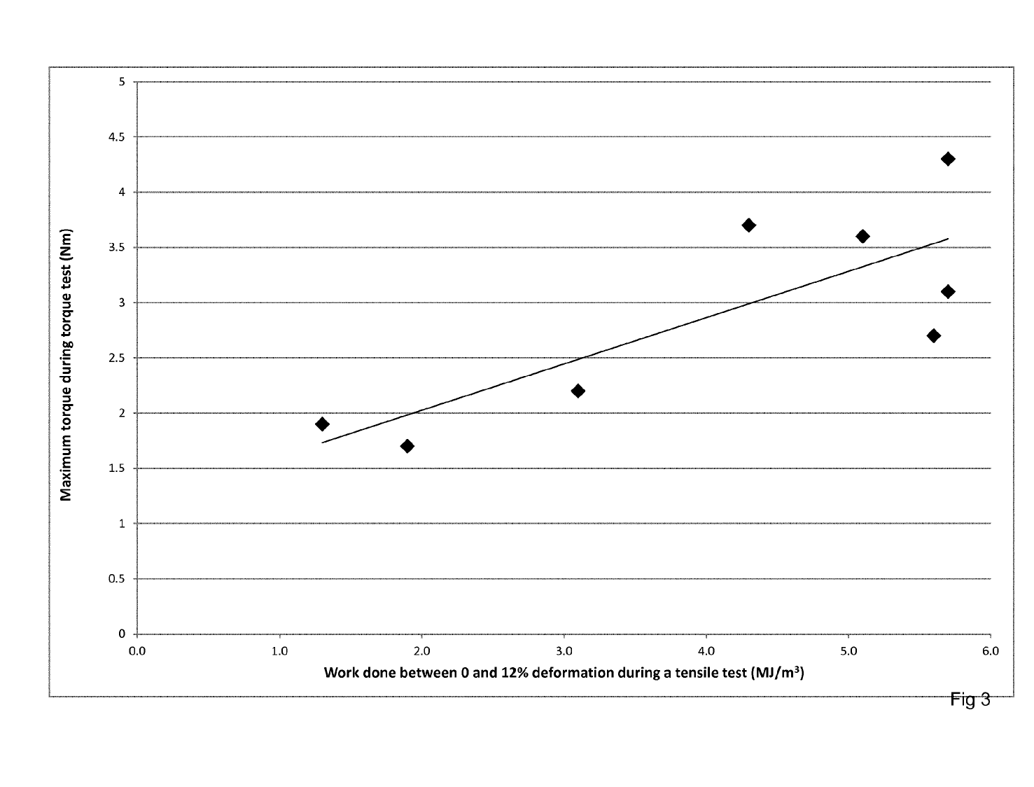

FIG. 3 is a graph of peak torque during tightening against work done between 0 and 12% deformation during a tensile test, for Examples 1-3, 8, 9, and 16, as well as Comparative Examples 2 and 8.

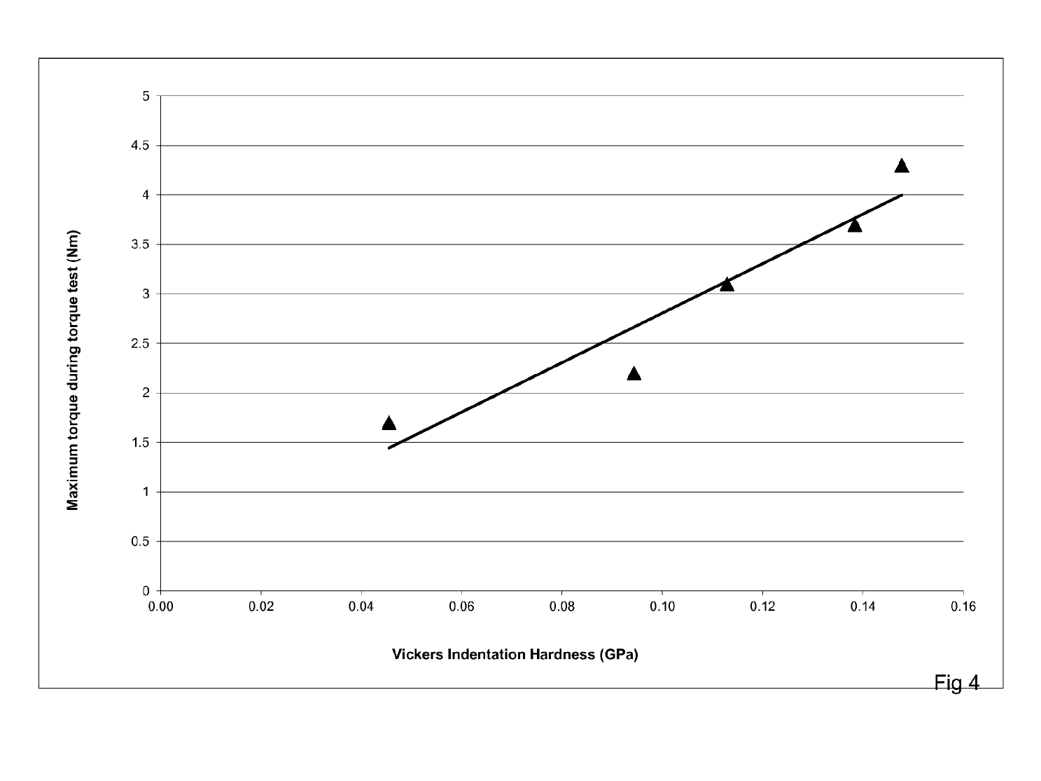

FIG. 4 is a graph of peak torque during tightening against Vickers indentation hardness for Examples, 1-3, 8, and Comparative Example 8.

### EXAMPLES

Gyproc Duraline™ gypsum boards were each provided with a lamina that was glued to a surface of the board using Bostik Aquagrip 29860 glue.

To quantify the resistance to overtightening, a graph of torque against rotation angle was plotted for a screw being inserted into a board. The screw was a No. 10 woodscrew having a length of 50 mm and a diameter of 5 mm. An example of such a graph is shown in FIG. 1. The area below the curve was calculated between the rotation angles of zero (corresponding to the peak torque) and 7.85 radians.

The area gives an indication of the work done in tightening the screw after peak torque has been attained. It is thought that the greater the work done after peak torque has been attained, the lower the risk of overtightening the screw and stripping material from the inner surface of the screw hole.

The peak torque was also measured for each board. The results are set out in Table 1.

### Vickers Hardness

Vickers hardness was measured for selected samples. A 50 mm×50 mm sample was cut from the lamina, and a Vickers diamond indenter pressed against the surface of the sample with a load (F) of 20 N for 34 s. The speed of the diamond indenter was 50 micron/second.

After removal of the indenter, the pyramidal print created on the surface of the sample was observed under a microscope and its two lateral dimensions d₁, d₂ were recorded in millimetres (that is, the distances between opposite corners).

The Vickers hardness was calculated using the following equation:

Hardness=0.001855F/d₁d₂

### Work Done Under Uniaxial Tensile Stress

A sample of 40 mm×200 mm was cut from the lamina using a rotary saw. The sample was then inserted into an Instron 4405 mechanical testing machine, the jaws of the machine being positioned on the sample at a separation of 150 mm. The samples were tested under uniaxial tension at a rate of 4.2 mm/min until 50% strain had been attained or the specimen had failed.

A curve of force against displacement was obtained and the area under the curve was calculated for deformation between 0 and 18 mm (corresponding to a strain of 0.12). In the case that the sample failed before a strain of 0.12 was attained, the area under the curve was calculated up to the strain at failure. The result obtained was normalised using the specimen dimensions of 150 mm (that is, the distance between the jaws)×40 mm×thickness of the lamina, to give a value for work done per unit volume.

TABLE 1

| | | | | Work | |
|---|---|---|---|---|---|
| | | | | done | |
| | | | | during | |
| | | Peak | Work | tensile | Hard- |
| Exam- | | Torque | done | testing | ness |
| ple | Lamina | (Nm) | (J) | (MJ/m³) | (GPa) |
| Exam- | 2 mm thick PVC sheet | 3.7 | 12.1 | 4.3 | 0.14 |
| ple 1 | | | | | |
| Exam- | 2 mm thick polycarbonate | 4.3 | 12.4 | 5.7 | 0.15 |
| ple 2 | sheet | | | | |
| Exam- | 2 mm thick nylon sheet | 3.1 | 14.5 | 5.7 | 0.11 |
| ple 3 | | | | | |
| Exam- | 2 mm thick Tufnol ™ | 2.7 | 14.0 | | |
| ple 4 | sheet | | | | |
| Exam- | 2 mm thick self-reinforced | 2.3 | 14.8 | | |
| ple 5 | polypropylene sheet (Curv) | | | | |
| Exam- | 1.34 mm thick self- | 2.5 | 15.2 | | |
| ple 6 | reinforced polypropylene | | | | |
| | sheet (Curv) | | | | |
| Exam- | 2 mm thick acetal sheet | 2.3 | 12.2 | | |
| ple 7 | | | | | |
| Exam- | 2 mm thick monolithic | 2.2 | 9.5 | 3.1 | 0.09 |
| ple 8 | polypropylene sheet | | | | |
| Exam- | 1.6 mm thick fibreglass | 3.6 | 8 | 5.1 | |
| ple 9 | sheet (Crane ETG160), | | | | |
| | having a glass fibre | | | | |
| | content of 44 wt %. | | | | |
| Exam- | Fibreglass sheet containing | 1.9 | 12.2 | | |
| ple 10 | non-woven glass fibre mat. | | | | |
| | Young's Modulus of the | | | | |
| | resin = 3600 MPa. Glass | | | | |
| | mat grammage = 450 g/m². | | | | |
| | Thickness = 1.1 mm. | | | | |
| Exam- | Fibreglass sheet containing | 1.7 | 9.9 | | |
| ple 11 | non-woven glass fibre mat. | | | | |
| | Young's Modulus of the | | | | |
| | resin = 3600 MPa. Glass | | | | |
| | mat grammage = 900 g/m². | | | | |
| | Thickness = 1.3 mm | | | | |
| Exam- | Fibreglass sheet containing | 1.8 | 11.5 | | |
| ple 12 | non-woven glass fibre mat. | | | | |
| | Young's Modulus of the | | | | |
| | resin = 8400 MPa. Glass | | | | |
| | mat grammage = 900 g/m². | | | | |
| | Thickness = 1.6 mm | | | | |
| Exam- | Fibreglass sheet containing | 2.0 | 13.1 | | |
| ple 13 | non-woven glass fibre mat. | | | | |
| | Young's Modulus of the | | | | |
| | resin = 3600 MPa. Glass | | | | |
| | mat grammage = 450 g/m². | | | | |
| | Thickness = 1.3 mm | | | | |
| Exam- | Fibreglass sheet containing | 2.1 | 11.9 | | |
| ple 14 | non-woven glass fibre mat. | | | | |
| | Young's Modulus of the | | | | |
| | resin = 3600 MPa. Glass | | | | |
| | mat grammage = 900 g/m². | | | | |
| | Thickness = 1.2 mm | | | | |
| Exam- | Fibreglass sheet containing | 1.8 | 10.2 | | |
| ple 15 | non-woven glass fibre mat. | | | | |
| | Young's Modulus of the | | | | |
| | resin = 8400 MPa. Glass | | | | |
| | mat grammage = 900 g/m². | | | | |
| | Thickness = 1.5 mm. | | | | |
| Exam- | FR4 grade glass- | 2.7 | 6.6 | 5.6 | |
| ple 16 | reinforced epoxy. | | | | |
| | Thickness = 1.55 mm | | | | |
| Compar- | 12 mm thick spruce | 2.0 | 10.4 | | |
| ative | plywood sheet | | | | |
| Exam- | | | | | |
| ple 1 | | | | | |
| Compar- | 1.6 mm thick fibreglass | 1.9 | 5.0 | 1.3 | |
| ative | sheet (Crane FCG 180). | | | | |
| Exam- | The glass fibre content is | | | | |
| ple 2 | 22 wt %. | | | | |
| Compar- | 2 mm fibreglass sheet | 2.1 | 6.2 | | |
| ative | from Lamilux. | | | | |
| Exam- | | | | | |
| ple 3 | | | | | |
| Compar- | 2 mm fibreglass sheet | 1.7 | 7.2 | | |
| ative | from Crane | | | | |
| Exam- | | | | | |
| ple 4 | | | | | |
| Compar- | 2 mm fibreglass sheet | 1.7 | 6.7 | | |
| ative | from Renolit. | | | | |
| Exam- | | | | | |
| ple 5 | | | | | |
| Compar- | Fibreglass sheet containing | 1.5 | 9.8 | | |
| ative | non-woven glass fibre mat. | | | | |
| Exam- | Young's Modulus of the | | | | |
| ple 6 | resin = 8400 MPa. Glass | | | | |
| | mat grammage = 450 g/m². | | | | |
| | Thickness = 1.8 mm | | | | |
| Compar- | Fibreglass sheet containing | 1.6 | 9.7 | | |
| ative | non-woven glass fibre mat. | | | | |
| Exam- | Young's Modulus of the | | | | |
| ple 7 | resin = 8400 MPa. Glass | | | | |
| | mat grammage = 450 g/m². | | | | |
| | Thickness = 1.3 mm | | | | |
| Compar- | 2 mm thick HDPE sheet | 1.7 | 9.3 | 1.9 | 0.05 |
| ative | | | | | |
| Exam- | | | | | |
| ple 8 | | | | | |

FIG. 2 shows a graph of torque against rotation angle for a screw being inserted into a board according to Example 6, Example 8, and Comparative Example 2 respectively.

FIG. 3 confirms that work done during tensile testing displays a good correlation with peak torque, a characteristic parameter of the screw-tightening process.

FIG. 4 confirms that, at least for thermoplastic laminae, hardness displays a good correlation with peak torque, a characteristic parameter of the screw-tightening process.

1. A panel for use in building construction, the panel comprising a plasterboard having two opposed faces, a polymer-based lamina being provided on one of the faces of the plasterboard,
the polymer-based lamina being characterised in that it is thinner than the plasterboard and in that it is provided by a material for which the work done under uniaxial tensile stress to achieve a tensile strain of up to 0.12 is greater than 2.1 MJ/m³.

2. A panel according to claim 1, wherein the polymer-based lamina is characterised in that it is provided by a material for which the work done under uniaxial tensile stress to achieve a tensile strain of up to 0.12 is greater than 2.9 MJ/m³, preferably greater than 3.8 MJ/m³.

3. A panel according to claim 1, wherein the polymer-based lamina is either a monolithic polymer or a composite having a polymer matrix.

4. A panel according to claim 2, wherein the polymer-based lamina is provided by a fibre-reinforced polymer.

5. A panel according to claim 1, wherein the polymer-based lamina comprises principally a thermoplastic polymer.

6. A panel according to claim 1, wherein the polymer-based lamina comprises principally a thermosetting polymer.

7. A panel according to claim 6, wherein the fibres and the matrix of the fibre-reinforced polymer are provided by the same polymer.

8. A panel according to claim 1, wherein the polymer-based lamina is solid and non-porous.

9. A panel according to claim 1, wherein the thickness of the polymer-based lamina is less than 20% of the thickness of the plasterboard.

10. A panel according to claim 1, wherein the thickness of the polymer-based lamina is less than 5 mm.

11. A panel according to claim 1, wherein the polymer-based lamina is selected from the group comprising: polyvinylchloride, polycarbonate, nylon, acetal, self-reinforced polypropylene, fibreglass and Bakelite.

12. A panel for use in building construction, the panel comprising a plasterboard having two opposed faces, a fibreglass sheet being provided on one of the faces of the plasterboard,
wherein the fibreglass sheet comprises a non-woven mat that is impregnated with resin, the Young's Modulus of the fibreglass sheet being in the range 4500-8000 MPa.

13. A panel for use in building construction, the panel comprising a plasterboard having two opposed faces, a polymer-based lamina being provided on one of the faces of the plasterboard,
wherein the polymer-based lamina is characterised in that its principal constituent by weight is a thermoplastic material having a Vickers indentation hardness greater than 0.06 GPa.

14. A partition comprising at least one panel according to claim 1, the panel being mounted onto a support structure, wherein the side of the panel on which the polymer-based lamina is provided faces towards the support structure.
